(19) United States
(12) Patent Application Publication
(10) Pub. No.: US 2006/0186131 A1
(43) Pub. Date: Aug. 24, 2006

(54) Combination wipe and container

(75) Inventor: Cynthia Jean Panning, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/061,269

(22) Filed: Feb. 18, 2005

(51) Int. Cl. G07F 11/00; B65H 1/00

(52) U.S. Cl. 221/2; 221/63

(57) ABSTRACT

A combination of a wet wipe and container includes a container defining an interior chamber and a container indicia disposed on the container. A first wipe is sized for storage inside the container interior chamber and adapted to clean waste from a body, the first wipe including a substrate having a moisture content greater than 10%. A first wipe indicia is disposed on the first wipe substrate. Each of the container and first wipe indicia includes a common visual element to provide information to a consumer that cross-references between the wipe and the container.

### FIELD OF THE INVENTION

The present disclosure generally relates to wipes used for hygienic purposes and containers therefor.

### BACKGROUND OF THE INVENTION

Various types of wipes are generally known in the art. These include dry wipes, identified herein as wipes having a water content of less than approximately 10%, and wet wipes, identified herein as wipes having a moisture content of greater than 10% by weight. Wet wipes are often used in hygienic applications to clean waste or other material from a body surface. For example, they may be used for cleaning hands, for cleaning small children and infants when changing diapers, or as a bath tissue (instead of toilet paper). Typically, a plurality or stack of wet wipes is sized for storage inside a container, often a plastic tub with a hinged lid on the top. The lid may be opened to remove an individual wet wipe sheet. Once the plurality of wipes is used, the container may be reused with replacement wipes.

As the use of wet wipes becomes more widespread, there is an increased likelihood that the replacement wipes used to refill a container originate from a source different than that of the original wipes. Where the replacement wipes and the original wipes are substantially similar, there is little risk of detriment to the consumer. On the other hand, the consumer may experience harmful or costly consequences when the replacement wipes significantly differ from the original wipes. For example, if the original wipes are suitable for disposal in a toilet while the replacement wipes are not, a consumer may unwillingly damage his or her plumbing by toilet disposal of the replacement wipes. Similarly, discomfort and/or injury may occur when using a replacement wipe having a chemical composition or substrate structure that is different from the original. Still further, when a consumer uses the original container with a different, inferior replacement wipe, he or she may associate the undesirable refill wipe characteristics with the container brand. It is advantageous, therefore, to provide visual reinforcement that the replacement wipes originate from the same trusted source as the tub and/or original wipes, or are otherwise compatible with the original container.

In addition, current replacement wipes fail to provide or direct a consumer to information related to one or more characteristics of the wipes. As noted above, whether or not a wipe is suitable for disposal in a toilet may result in serious consequences to the consumer, and therefore communication of a wipe's suitability for toilet disposal is desirable. In addition, a wipe may have a particular procedure for use or may exhibit other characteristics that could be advantageously communicated to the consumer.

More recently, wet wipes and the containers in which they are stored have been modified for use by, and marketing efforts have been targeted to, children. The foregoing problems with conventional wipes are exacerbated when the user is a child.

### BRIEF DESCRIPTION OF THE DRAWINGS

FIG. 1 is a perspective view of a container for storing wipes;

FIG. 2 is a plan view of one exemplary embodiment of a wipe having indicia disposed thereon;

FIG. 3 is an enlarged detail view of one exemplary embodiment of indicia for use on both the container and wipe;

FIG. 4 is a plan view of a wipe having alternative indicia;

FIG. 5 is a plan view of a series of two wet wipes that may be alternately provided in a stack of wipes; and

FIG. 6 is a plan view of a wipe including edge printing.

### DETAILED DESCRIPTION OF THE INVENTION

The present disclosure is directed to a combination of a wipe and container carrying cross-referencing indicia. The indicia provided on both the container and the wipe may include a common visual element that communicates compatibility between the container and the wipe or other information to a consumer. In certain exemplary embodiments, the container and/or the wipe communicates suitability of the wipe for disposal in a toilet. These and other embodiments are disclosed in greater detail below.

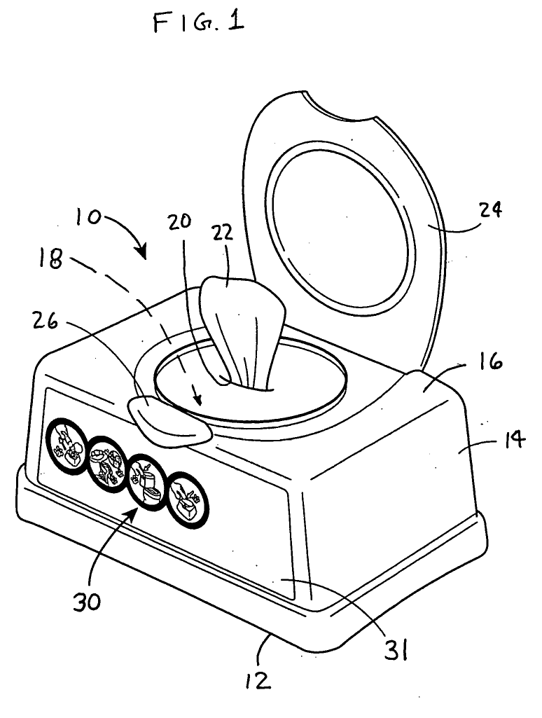

A container 10 for storing wipes is illustrated at FIG. 1. The container 10 includes a base 12, side wall 14, and top wall 16. The base 12, side wall 14, and top wall 16 define an interior chamber 18 sized to store one or more wipes. The top wall 16 further defines an opening 20 in communication with the interior chamber 18. The opening 20 is sized to allow a wipe 22 to pass therethrough, thereby allowing a user to remove a wipe from the container 10. A lid 24 is pivotably coupled to the container 10 and is moveable between an open position, which allows access to the opening 20, and a closed position, which covers the opening 20. A latch 26 is also coupled to the container 10 for selectively securing the lid 24 in the closed position. The container 10, lid 24, and latch 26 may be formed from any known container material, such as plastic.

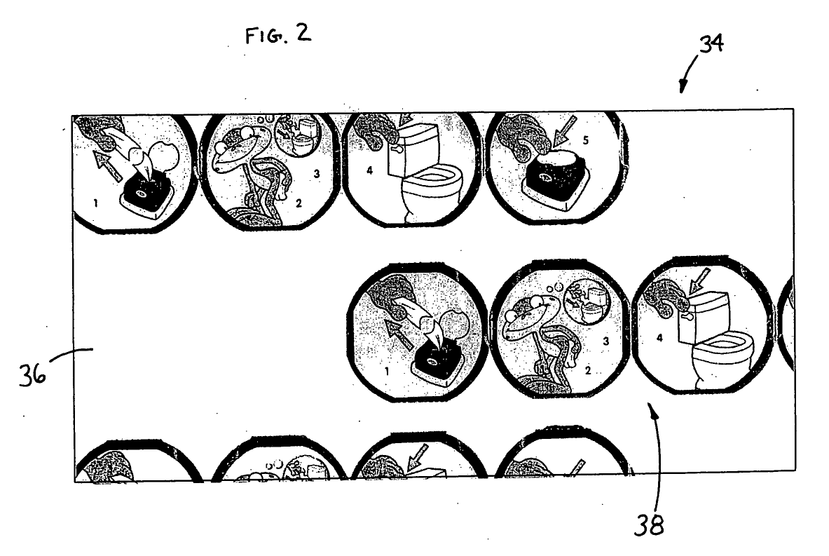

An exemplary embodiment of a wipe 34 for use with the container 10 is illustrated at FIG. 2. The wipe 34 includes a substrate 36 having a substantially rectangular shape sized for storage inside the container interior chamber 18. The substrate 36 may be formed of any known material used for wipes including, but not limited to, woven or non-woven foam, web, sponge, battings, balls, puffs, or film material. The substrate material may be man-made or natural, and may be produced by any method known in the art, such as dry forming, air-laying, wet laying, melt blown, spun bonded, needle punched, or spun laced. Exemplary man-made fibers include fibers manufactured from cellulose, for example derivates of or regenerated cellulose.

In the preferred embodiment, the wipe 34 is a wet wipe suitable for disposal in a toilet. As such, the wipe substrate 36 preferably comprises a cellulosic content, or other biodegradable fiber content, of at least approximately 80%. Furthermore, as used herein, the term “wet wipe” indicates a wipe substrate having a moisture content of greater than 10% by weight. Such wet wipes often having a moisture content of approximately 50% to approximately 400% or more by weight. This is in contrast to a “dry wipe” which is used herein to indicate a wipe substrate having a moisture content of less than approximately 10%.

The substrate 36 may further include other components or materials added thereto, as known in the art, to improve appearance, surface texture, color, or odor. The substrate 36 may further incorporate a cleaning composition. As used herein, the term “incorporate” means that the substrate is coated or impregnated with a preferably liquid cleaning composition. The composition may be formulated in any suitable form, for example as a solid, paste, or liquid. The composition may include a variety of ingredients including, but not limited to peroxygen bleach, disinfecting components, organic acids, surfactants, chelants, solvents, builders, stabilizers, bleach activators, soil suspenders, dye transfer agents, brighteners, perfumes, anti-dusting agents, enzymes, surfactants, rheology modifiers, dispersant, dye transfer inhibitors, pigments, perfumes, radical scavengers, ph buffers, dyes, or mixtures thereof.

Container indicia 30 and wipe indicia 38 are disposed on the container 10 and wipe 34, respectively, to communicate information to a consumer. As used herein, the phrase “disposed on” is used to mean that the indicia 30, 38 are disposed on or otherwise provided with the container 10 and wipe 34. For example, the container indicia 30 may be printed directly on the container side wall 14, or printed on a separate substrate, such as a label 31 that is affixed to the container 10. The indicia 30, 38 may be applied using any known method, including printing. As used herein, the term “print” is intended to broadly cover all forms of forming visible marks on a product, container, label, tag, wipe, or other substrate. The indicia 30, 38 are selected to communicate information to a user. The information may relate to the general compatibility or desirability of using the wipe 34 with the container 10, or may provide instructional or descriptive information regarding the wipe 34 and/or container 10.

As used herein, the term “communicate” refers to the ability of indicia to impress an idea or message upon, or trigger a cognitive response within, a user. As such, communication may rely upon a user's experience or knowledge to arrive at the intended message. Additionally or alternatively, the indicia may illustrate simple concepts that are understood at a basic or visceral level that does not require the prior knowledge or experience of a user. In any event, the indicia is cognitively functional in that it conveys a message that is generally capable of being understood by a recipient user.

The indicia may be in the form of any visual communication suitable for communicating information regarding the wipe and/or container to a consumer. Accordingly, the indicia may include icons, which may comprise, but are not limited to, pictorial symbols, photographs, drawings, cartoons, and logos. For example, the icons may be provided as drawings of a child or an anthropomorphic image of an animal using the wipe and/or container. Similarly, the icons may include well-known cartoon characters or brand logos, or characters specifically created to be associated with the products. The icons may further include symbols, such as arrows, to indicate motion or movement.

The indicia may be arranged in any manner as long as they communicate the desired information to a consumer. The indicia may be a single icon or a series of icons. Each icon may include one or more visual prompts. Where a series of icons are provided, the images may be arranged in any suitable fashion, such as, but not limited to, vertically, horizontally, diagonally, circular, and combination thereof.

The indicia may optionally include a character graphic that can increase a user's interest in the product. The term “character graphic” is used herein to refer to a graphic containing an anthropomorphic image, and in particular an image having or suggesting human form or appearance which ascribes human motivations, characteristics or behavior to inanimate objects, animals, natural phenomena, toys, cartoon characters, or the like. The character graphic may be associated with popular characters in the media, advertising or well known in a particular culture. Ideally they are characters that the user, particularly if a child, care about and want to identify with.

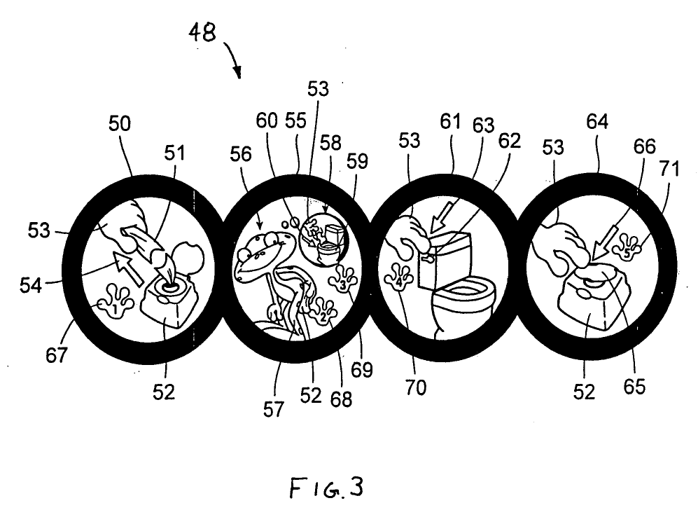

Exemplary indicia 48 that may be used as both the container indicia 30 and the wipe indicia 38 is illustrated at FIG. 3. The illustrated indicia 48 includes a series of icons to provide information regarding use and disposal of the wipe. Specifically, indicia 48 include a first icon 50 showing how a toilet wipe 51 is removed from a container 52 of disposable, pre-moistened toilet wipes. A hand 53 is shown grasping the toilet wipe 52 and an arrow 54 illustrates the direction in which the toilet wipe 52 is to be pulled to remove it from the container 52. A second icon 55 includes two visual prompts: a first visual prompt 56 illustrating an anthropomorphic animal, in this case a frog 57, wiping a perianal area with the toilet wipe 52, and a second visual prompt 58 showing the hand 53 of the frog 57 disposing of the toilet wipe 52 in a toilet 59. An arrow 60 is provided in the second visual prompt to show the direction in which to dispose of the toilet wipe 52 into the toilet 59. A third icon 61 illustrates a flushing step by showing a hand 53 of the frog 57 engaging a toilet flusher 62 and an arrow 63 illustrating the direction in which to push on the flusher 62. A fourth icon 64 illustrates closing of the wipe container 52 by showing the frog hand 53 engaging a container flag 65 and applying a force in the direction of arrow 66.

The icons may further include numerical representations to identify the order in which to perform the steps shown in the icons. As illustrated in FIG. 3, the first icon 50 includes a graphical representation 67 which indicates that it is the first step. The second icon 55 includes graphical representations 68, 69 indicating that wiping and discarding are the second and third steps, respectively. The third icon 61 includes a graphical representation 70 indicating that flushing is the fourth step while the fourth icon 64 includes a graphical representation 71 indicating that closing the wipe container is a fifth step.

As noted above, the same indicia 48 may be provided on both the container 10 and the wipe 34. As such, it will be appreciated that both the container indicia 30 and wipe indicia 38 incorporate several common visual elements. For example, both indicia include the common visual elements of an image of a container, an image of an anthropomorphic frog, and an image of a toilet, among others. The use of common visual elements conveys to a consumer that the wipe 34 and container 10 are intended for use with one another.

While the illustrated embodiment shows both the container 10 and wipe 34 having identical indicia, it will be appreciated that the indicia may be different, as long as the container indicia 30 and the wipe indicia 38 include at least one common visual element. Furthermore, the common visual element need not be identical in both the container indicia 30 and wipe indicia 38, but instead may be merely similar. Examples of similar graphical representations that would be considered as illustrating a common visual element include similar icon themes (such as using non-identical images of an anthropomorphic frog), similar color schemes, or similar text fonts or syntax. Furthermore, while the embodiment of FIGS. 1-3 discloses container indicia 30 and wipe indicia 38 with several common visual elements, only a single common visual element may be sufficient to communicate the desired information to a consumer.

While the exemplary indicia 48 includes a series of icons as common visual elements, other types of graphical representations may be used. For example, the common visual element may be a common color or color scheme shared by both the container 10 and the wipe 34. Alternatively, the common visual element may be similar text provided on both the container 10 and wipe 34. The common text may be a brand name, catch phrase, or other words that are marketed in conjunction, or are otherwise associated, with the container 10 and wipe 34.

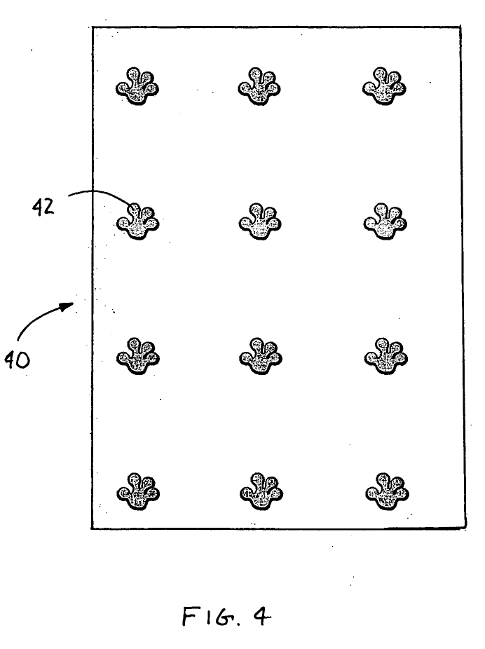

Furthermore, while the exemplary icons illustrate a series of steps, the icons need not instruct use and/or disposal of the wipe. As shown in FIG. 4, for example, a wipe 40 may include a simple repeating pattern, such as the hand print 42 of an anthropomorphic frog. The container indicia 30 may include a similar hand pattern or may include a visual element that is related to the hand print, such as the full body of an anthropomorphic frog. While such indicia do not provide instructions regarding use of the wipe or container, they communicate to a consumer that the wipe 34 is intended for use, or is otherwise compatible, with the container 10.

In addition to including a common visual element, at least one of the container indicia 30 and wipe indicia 38 may further include an informational image communicating a characteristic of the first wipe 34 to the consumer. For a wipe that is toilet disposable, for example, the indicia may include an informational image communicating to the consumer the ability to dispose of the wipe in a toilet. As used herein, the term “toilet disposable” includes the following characteristics of a wipe: flushability, dispersability, and biodegradability. As used herein the term “flushable” and “flushabilty” refer to a product's ability to pass through typically commercially available household toilets and plumbing drainage systems without causing clogging or similar problems that can be directly associated with the physical structure of the product. The term “dispersible” as applied herein to a wipe refers to an article which will disperse into at least two fragments in mildly agitated water. Such a device will break into pieces in a conventional toilet and/or domestic plumbing system, and will ultimately affectively process through a sewage treatment system. The term “biodegradable” as used herein refers to a wipe which is preferably partially constructed of biodegradable materials.

The exemplary indicia 48 includes an informational image communicating the ability to dispose of the wipe 36 in a toilet. As best shown with reference to FIG. 3, icon 55 includes visual prompt 58 showing a hand 53 of a frog 57 disposing of a toilet wipe 52 into a toilet 59. Accordingly, when provided on the container 10 or wipe 34, the visual prompt 58 will communicate to the consumer that the wipe is capable of being disposed in a toilet.

The informational image may communicate other concepts in addition or alternative to the ability to dispose of the wipe in a toilet. For example, the informational image may simply communicate that the wipe 34 is compatible with the container 10. Referring again to the exemplary embodiment illustrated at FIG. 3, the indicia includes icon 50 including a graphical representation of a container 52. The graphical representation 52 has an appearance similar to that of the actual container 10, and therefore a consumer will understand that wipe 34 may be used with the container 10. Still further, the similar appearance of the graphical representation 52 and the container 10 may communicate to the consumer that the wipe 34 and container 10 originate from the same source. When considered in the context of using refill wipes in the container 10, the consumer will be comforted to know that the replacement wipes come from the same source that provided the original wipes, and therefore will exhibit the same characteristics to which he or she is accustomed.

A plurality of replacement wipes may have different or alternating indicia to assist a consumer in using a proper amount of wipes. Replacement wipes are typically provided in the form of a stack of multiple wipes. If care is not exercised, it is possible that more than one wipe may be pulled from the container. If too many of wipes are simultaneously disposed of in a toilet, it is possible that the wipes may clog the plumbing. This is particularly a problem when the wipes are used by a child, who may enjoy using (or at least dispensing) the wipes and therefore may deliberately dispose of an excessive number of wipes without appreciating the potential plumbing consequences.

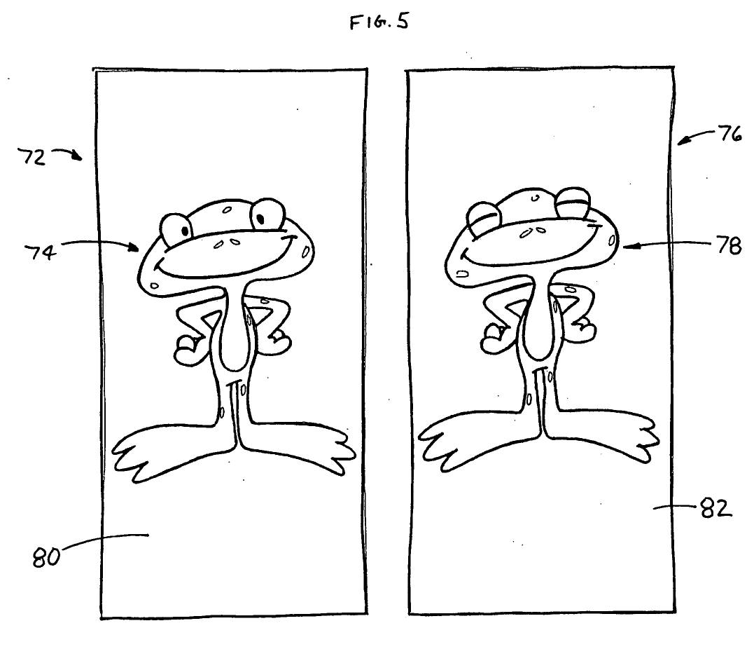

To help a user, and particularly a child user, identify the proper number of wipes to use, different indicia may be applied to adjacent wipes in a stack of refill wipes. As illustrated in FIG. 5, a first wipe 72 may include first indicia 74 while a second wipe 76 may include second indicia 78. The first wipe indicia 74 include a first wipe usage image comprising an anthropomorphic frog with its eyes open, while the second wipe indicia 78 include a second wipe usage image comprising an anthropomorphic frog with its eyes closed. By alternating first and second wipes 72, 76 in a stack of wipes, the user will receive a reminder as to the number of wipes used, thereby improving the user's ability to monitor, and limit, if necessary, his or her use of wipes. The differences between the first and second wipe indicia 74, 78 are also readily identifiable by a child. The significance of the different wipe indicia may be communicated to the user by the wipe, container, or other information provided with these products.

While the first and second wipe usage images are illustrated as icons, it will be appreciated that the indicia may comprise alternating colors, text, or other graphical representations. For example, the first wipe 72 may have a background 80 of a first color while the second wipe 76 may have a background 82 of a second color. The first and second background colors 80, 82 may be used alone, without the character graphics, to identify the first and second wipes 72, 76.

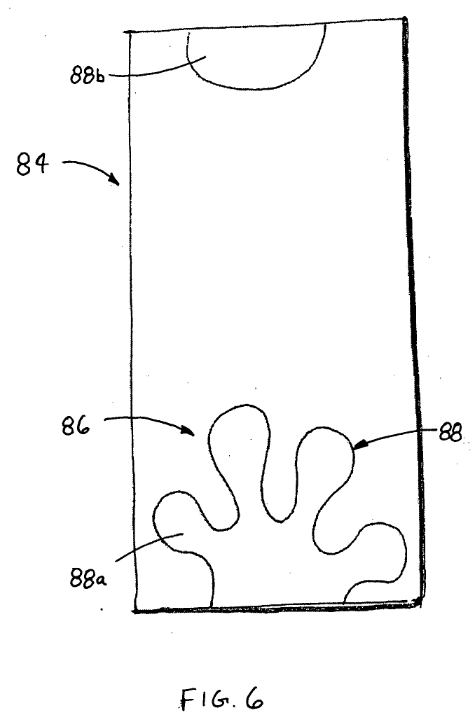

The location of the indicia on the wipe may further communicate to the user where to grasp the wipe during use. Specifically, it has been found that printing on the edge of a wipe will encourage a user to grasp the wipe at the edge location. In the exemplary embodiment illustrated at FIG. 6, a wipe 84 includes indicia 86 including an icon 88 of an anthropomorphic frog hand. The icon 88 includes a first portion 88a and a second portion 88b located on opposite edges of the wipe 84, so that the wipe must be bent or rolled to form a complete image of the frog hand. As a result, a user is encouraged to hold the wipe 84 in the intended manner by wrapping the wipe 84 around his or her hand to complete the icon 88.

Graphics other than the image of a hand may be used to attract a user's attention and indicate a gripping location. When the wipes are intended for use by a child, they may carry images of a cookie, spoon, or other object commonly grasped by a child. Alternatively, the indicia may include images of stars, balloons, or other items easily recognized by a child, or patterns and decorative designs that would attract a child's attention.

The indicia disclosed herein are particularly suited for wipes and containers intended for use by children. As such, the exemplary indicia illustrated herein are intended to be readily understandable by a pre-literate child. As used herein, the terms “pre-literate” and “incapable of reading” are used interchangeably to mean the inability of a child to correctly understand, comprehend and follow prompts written in a language that the child can speak without assistance of a caregiver. The ability of a child to recognize letters and/or read one or two isolated words still means that the child is “incapable of reading” since he or she is unable to understand, comprehend and follow such written prompts, without assistance. However, this definition of “incapable of reading” does not exclude the child from being able to understand, comprehend and follow visual prompts which are presented in the form of drawings, icons, symbols, gestures, cartoons and the like. Furthermore, while the disclosed embodiments are capable of being understood by a pre-literate child, it is not necessary for the indicia to be understood at this level.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this disclosure.

What is claimed is:

1. A combination wet wipe and container, comprising:
a container defining an interior chamber;
a container indicia disposed on the container;
a first wipe sized for storage inside the container interior chamber and adapted to clean waste from a body, the first wipe including a substrate having a moisture content greater than 10% by weight; and
a first wipe indicia disposed on the first wipe substrate;
wherein each of the container and first wipe indicia includes a common visual element and at least one indicia in the group of indicia including the container indicia and the wipe indicia further includes an informational image communicating a characteristic of the first wipe substrate.

2. The combination of claim 1, in which the first wipe substrate comprises a material suitable for disposal in a toilet and in which the informational image communicates disposal of the first wipe in a toilet.

3. The combination of claim 1, in which the informational image comprises an icon.

4. The combination of claim 1, in which the informational image comprises text.

5. The combination of claim 1, in which the informational image communicates compatibility of the first wipe with the container.

6. The combination of claim 1, in which the common visual element comprises a color.

7. The combination of claim 1, in which the common visual element comprises an icon.

8. The combination of claim 1, in which the common visual element comprises text.

9. The combination of claim 1, in which the first wipe image comprises first and second image sections positioned on opposite edges of the wipe substrate.

10. The combination of claim 1, in which the first wipe substrate comprises a cellulosic content of at least approximately 80%.

11. A combination wet wipe and container, comprising:
a container defining an interior chamber;
a container indicia disposed on the container;
a first wipe sized for storage inside the container interior chamber and adapted to clean waste from a body, the first wipe including a substrate having a moisture content greater than 10% by weight;
a second wipe sized for storage inside the container interior chamber and adapted to clean waste from a body, the second wipe including a substrate having a moisture content greater than 10% by weight,
a first wipe indicia disposed on the first wipe substrate including a first wipe usage image; and
a second wipe indicia disposed on the second wipe substrate including a second wipe usage image.

12. The combination of claim 11, in which the first wipe usage image comprises a first color and the second wipe usage image comprises a second color.

13. The combination of claim 11, in which the first wipe usage image comprises a first icon and the second wipe usage image comprises a second icon.

14. The combination of claim 11, in which each of the container indicia, the first wipe indicia, and the second wipe indicia includes a common visual element

15. A combination wet wipe and container, comprising:
a container defining an interior chamber;
a container indicia disposed on the container;
a first wipe sized for storage inside the container interior chamber and adapted to clean waste from a body, the first wipe including a substrate formed of a material suitable for disposal in a toilet and having a moisture content greater than 10% by weight; and
a first wipe indicia disposed on the first wipe substrate;
wherein each of the container and first wipe indicia includes a common visual element, and wherein at least one indicia in the group of indicia including the container indicia and the wipe indicia further includes an informational image communicating disposal of the first wipe in a toilet.

16. The combination of claim 15, in which the common visual element comprises a color.

17. The combination of claim 15, in which the common visual element comprises an icon.

18. The combination of claim 15, in which the common visual element comprises text.

19. A combination wet wipe and container, comprising:
a container defining an interior chamber;
a container indicia disposed on the container;
a first wipe sized for storage inside the container interior chamber and adapted to clean waste from a body, the first wipe including a substrate having a moisture content greater than 10% by weight; and
a first wipe indicia disposed on the first wipe substrate;
wherein each of the container and first wipe indicia includes a visual element associated with a common source of origination of the container and first wipe.

20. The combination of claim 19, in which the common visual element comprises a color.

21. The combination of claim 19, in which the common visual element comprises an icon.

22. The combination of claim 19, in which the common visual element comprises text.
